(19) United States
(12) Patent Application Publication
(10) Pub. No.: US 2025/0205903 A1
(43) Pub. Date: Jun. 26, 2025

(54) METHOD FOR CONTROLLING THE POSITION OF AN END EFFECTOR OF A MULTI-AXIS ROBOT AND SYSTEM EXECUTING THE METHOD

(71) Applicants: Airbus Operations SAS, TOULOUSE (FR); Airbus Operations S.L., GETAFE (ES)

(72) Inventors: Kledder Hugo CORREIA POUSAS DE OLIVEIRA, GETAFE (ES); Damien VAN DAMME, TOULOUSE (FR); Noelie RAMUZAT, TOULOUSE (FR)

(21) Appl. No.: 18/976,767

(22) Filed: Dec. 11, 2024

(30) Foreign Application Priority Data
Dec. 22, 2023 (FR) 2314998

(51) Int. Cl. B25J 13/08; B25J 9/12; B25J 9/16; B25J 11/00; B25J 15/00

(52) U.S. Cl. CPC B25J 13/087; B25J 9/12; B25J 9/1679; B25J 11/005; B25J 15/0019

(57) ABSTRACT

A method for controlling the position of an end effector of a multi-axis robot, in particular used to drill aeronautical-equipment parts in a first direction. The method regulates the clamping force of the tool against a workpiece in the first direction while automatically controlling the position of the end effector in two other directions that are perpendicular to each other and each perpendicular to the first direction, based on pieces of information representative of forces oriented in the first direction and obtained from three separate sensors. A control device is configured to execute the method for positioning the end effector. Reducing or preventing slippage of a tool over a workpiece improves the quality of machining operations carried out by the tool-bearing end effector.

### CROSS-REFERENCES TO RELATED APPLICATIONS

This application claims the benefit of French Patent Application Number 2314998 filed on Dec. 22, 2023, the entire disclosure of which is incorporated herein by way of reference.

### FIELD OF THE INVENTION

The present invention relates to a method for controlling the position of an end effector of a multi-axis robot configured in particular to carry out drilling operations on aeronautical-equipment parts. At least one embodiment relates to automatic control of the position of an end effector of a multi-axis robot with a view to preventing any skidding of the tool borne by the end effector over the surface of a workpiece.

### BACKGROUND OF THE INVENTION

It is known to use multi-axis robots to carry out industrial machining operations with the aim of carrying out these operations at a high rate and with a high level of precision and reliability. Drilling, milling, sanding, riveting and welding operations, for example, are carried out using a multi-axis robot provided with an end effector. The positional control of this type of robot allows a high degree of positional precision to be achieved and therefore operations to be carried out with a high degree of precision, in particular by regulating the clamping force of the tool against a surface of a workpiece by means of a strain sensor (also called a force sensor, or strain gauge). However, there are conditions under which a tool borne by an end effector of a multi-axis robot and effecting a machining operation may slide or skid over the surface of the workpiece, resulting in imperfections in the result, or even damage to the workpiece. For example, a drilling tool boring along an axis perpendicular to the surface of a workpiece may deviate slightly or slip and cause a drilling error. There is therefore a need to control the distribution of the forces on an end effector of a multi-axis robot so as to reduce the risk of unwanted slippage of a tool or end effector over a workpiece.

The situation could be improved.

### SUMMARY OF THE INVENTION

One object of the present invention is to provide a method for controlling an end effector of a multi-axis robot with a view to reducing at least some of the drawbacks of the prior art, and an improved control device for executing such a method.

To this end, a method for positioning an end effector of a multi-axis robot is provided, the end effector being configured to bear a tool extending longitudinally in a first direction and the end effector comprising at least three strain sensors configured to deliver pieces of information representative of stresses exerted on the end effector in the first direction, the method being executed in a device for controlling positioning of the end effector, which device is connected to said three strain sensors and is connected to positioning actuators of said robot, which are configured to position the end effector in at least the first direction and two other directions that are perpendicular to each other and each perpendicular to the first direction, the method being such that it comprises, executed iteratively, the following steps:
obtaining three first pieces of information representative of stresses exerted in the first direction, which pieces of information are obtained from the three sensors, respectively, and:
effecting a first automatic control of the position of the end effector in the first direction based on the three first pieces of information while effecting a second automatic control of the position of said end effector in said other two directions based on said three first pieces of information.

Advantageously, it is thus possible to detect an imbalance between the forces applied to the three sensors, to detect a risk of slippage and therefore to prevent a tool borne by the end effector from slipping over the surface of a workpiece.

The method according to the invention may further comprise the following optional features, alone or in any combination:
The fact of effecting the first automatic control of the position of the end effector comprises the fact of determining a first difference between the sum of the stresses corresponding to said three first pieces of information and a predetermined target stress in the first direction, and, if said determined first difference is greater than a predefined first threshold value, correcting a positioning setpoint of the end effector of said robot in the first direction so as to reduce the first difference.
The fact of effecting the second automatic control of the position of the end effector comprises the fact of determining second differences between the average of said three first pieces of information and each of said first pieces of information, and, if at least one of said determined second differences is greater than a predefined second threshold value, correcting a positioning setpoint of the end effector of said robot in either or both of said two other directions so as to reduce said second difference or differences.
The method comprises a preliminary step of positioning the end effector facing and flush with a surface of a workpiece by virtue of at least three optical laser transceiver modules.
The method is configured to effect drilling operations on aeronautical-equipment parts by means of the multi-axis robot bearing a drilling tool.

Another subject of the invention is a device for controlling the position (or positioning) of an end effector of a multi-axis robot, the end effector being configured to bear a tool extending longitudinally in a first direction and the end effector comprising at least three strain sensors configured to deliver pieces of information representative of stresses exerted on the end effector in the first direction, said device for controlling the position of the end effector being connected to said three strain sensors and being connected to positioning actuators of the robot, which are configured to position said end effector in at least the first direction and two other directions that are perpendicular to each other and each perpendicular to the first direction, said control device being such that it comprises electronic circuitry configured to:
obtain three first pieces of information representative of stresses exerted in the first direction, from three sensors, respectively, and,
effect a first automatic control of the position of the end effector in the first direction based on the three first pieces of information while effecting a second automatic control of the position of the end effector in the other two directions based on the three first pieces of information.

The control device according to the invention may further comprise the following optional features, alone or in any combination:
The electronic circuitry configured to effect the first automatic control comprises electronic circuitry configured to determine a first difference between the sum of the three first pieces of information and a predetermined target stress in the first direction, and to, if said determined first difference is greater than a predefined first threshold value, correct a positioning setpoint of the end effector of said robot in the first direction so as to reduce said first difference.
The electronic circuitry configured to effect the second automatic control of the position of the end effector comprises electronic circuitry configured to determine second differences between the average of said three first pieces of information and each of the first pieces of information, respectively, and to, if at least one of the determined second differences is greater than a predefined second threshold value, correct a positioning setpoint of the end effector of the robot in either or both of the two other directions so as to reduce the second difference or differences.
The device for controlling positioning of an end effector of a multi-axis robot further comprises electronic circuitry configured to effect preliminary positioning of the end effector facing and flush with a target surface of a workpiece by virtue of at least three optical laser transceiver modules.
The control device is configured to position the end effector to effect drilling operations on aeronautical-equipment parts by means of the multi-axis robot bearing a drilling tool.

Another subject of the invention is a computer program product comprising program code instructions for executing the steps of the method described above, when said program is executed by a processor of a device for controlling positioning of an end effector of a multi-axis robot.

Lastly, the invention relates to a storage medium comprising a computer program product such as mentioned above.

### BRIEF DESCRIPTION OF THE DRAWINGS

The above-mentioned features of the invention, along with others, will become more clearly apparent on reading the following description of one example of embodiment, said description being given with reference to the appended drawings, in which:

FIG. 1 illustrates an end effector of a multi-axis robot comprising three strain sensors, according to one embodiment of the invention, when a borne tool is positioned retracted into the end effector;

FIG. 2 illustrates the end effector already shown in FIG. 1, according to one embodiment, when the tool is positioned protruding with a view to drilling a workpiece;

FIG. 3 is a flowchart illustrating a method for positioning the end effector shown in FIG. 1 and FIG. 2 comprising two automatic controls of the position of the end effector, according to one embodiment;

FIG. 4a is a flowchart illustrating details of a first automatic control of the position of the end effector according to the method already shown in FIG. 3;

FIG. 4b is a flowchart illustrating details of a second automatic control of the position of the end effector according to the method already shown in FIG. 3; and

FIG. 5 is a diagram illustrating an internal architecture of a device for controlling positioning of the end effector shown in FIG. 1 and FIG. 2, configured to execute a method such as shown in FIG. 3.

### DETAILED DESCRIPTION OF EMBODIMENTS

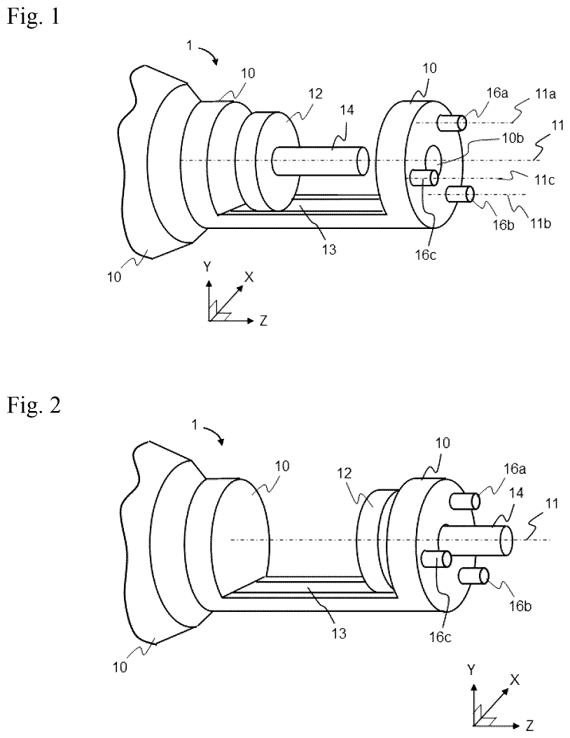

FIG. 1 shows an end effector 1 of a multi-axis industrial robot configured to effect in particular drilling operations on aeronautical-equipment parts. According to one embodiment, the robot to which the end effector 1 is attached is a robot having six axes of movement. The end effector 1 is positioned by a control device (or system) with reference to an orthonormal coordinate system X, Y, Z. The end effector 1 comprises a body 10 an end part of which, called the “distal end part”, contains a through-bore 10b configured for passage of an elongate tool, for example a drilling tool, or even for passage of an elongate tool-bearing shaft forming part of a tool.

According to the described example, the end effector 1 comprises a motorized module 12 in which a drilling tool 14 (a drill bit) is inserted. The motorized module 12 is arranged on the body 10 of the end effector 1 by virtue of a sliding connection 13 and may be translated along this sliding connection 13 by means of a motor (not shown in the figure). The motorized module 12 further comprises a motor for driving the tool 14 to rotate (not shown in the figure). A translation of the assembly composed of the motorized module 12 and the tool 14 takes place along an axis 11. The axis 11 is a longitudinal axis of the end effector 1, parallel to the Z-direction of the coordinate system X, Y, Z and is furthermore the longitudinal axis along which the bore 10b in the distal end part of the body 10 is arranged. Advantageously, the distal end part of the body 10 of the end effector 1 comprises at least three strain sensors 16a, 16b and 16c that are arranged in the same plane, with a layout describing a triangle, and that are oriented along axes 11a, 11b and 11c, respectively, parallel to the axis 11, each strain sensor being configured to deliver, to a remote control device, pieces of information representative of stresses (forces) measured and applied in a direction parallel to its longitudinal axis. In other words, the sensor 16a is configured to deliver pieces of information Se1 representative of stresses applied to it along the axis 11a, the sensor 16b is configured to deliver pieces of information Se2 representative of stresses applied to it along the axis 11b and the sensor 16c is configured to deliver pieces of information Se3 representative of stresses applied to it along the axis 11c. In other words, each of the sensors 16a, 16b and 16c is configured to deliver pieces of information representative of stresses applied to it in a direction parallel to the axis 11, and therefore in the Z-direction of the coordinate system X, Y, Z.

In the present description, the term “stress” refers to a component of a given mechanical force along a predefined axis. Thus, the terms “stress along an axis” and “force along an axis” are equivalent to each other.

Advantageously, the sensors 16a, 16b and 16c are arranged so as not to form an alignment. According to one embodiment, the sensors 16a, 16b and 16c are arranged equidistant from the axis 11, in the same plane, and so that the angle made by two sensors neighbouring each other with respect to the intersection of the axis 11 and this plane is an angle of 120°. Such an arrangement of the sensors 16a, 16b and 16c makes it possible to detect an imbalance between the forces measured by each of the sensors when the distal end part of the body 10 is advanced toward a workpiece so that the ends of the sensors 16a, 16b and 16c make contact with the workpiece. With such an arrangement, and when the axis 11 is positioned perpendicular to the surface of a workpiece, facing a target point of this surface (for example the centre of a drill hole to be produced) and in the absence of slippage, the stresses measured by the respective sensors 16a, 16b and 16c are equal to one another or substantially equal to one another (to within a margin of error judged acceptable). Such a configuration of the end effector 1 makes it possible to clamp the end effector against a workpiece, via the three sensors 16a, 16b and 16c, which act as bearing pins, then to gradually and controllably also clamp the tool 14 against the surface of the workpiece and to ensure a good distribution of the stresses measured by the three strain sensors 16a, 16b and 16c. In the case where an imbalance is detected, it may be corrected by modifying the position of the end effector 1 in the X- and/or Y-directions, which are perpendicular to each other and each perpendicular to the Z-direction of the coordinate system X, Y, Z.

FIG. 2 shows the end effector 1 when the motorized module 12 bearing the tool 14 has moved translationally along the sliding connection 13 so that the tool 14 protrudes with respect to the distal end part of the body 10 bearing the three strain sensors 16a, 16b and 16c. The details of implementation of the multi-axis robot comprising the end effector 1 are not described here insofar as they do not contribute to comprehension of the invention. It should simply be noted that the movements of the end effector 1 are controlled (and therefore its position too) by a control device 100 (illustrated in FIG. 5) that in particular acts on the basis of pieces of information delivered by the sensors 16a, 16b and 16c and of corresponding setpoints for machining operations to be carried out, and that acts on actuators of the robot that are configured to generate movements along the six axes of the robot and that allow the end effector 1 to be positioned with reference to the coordinate system X, Y, Z.

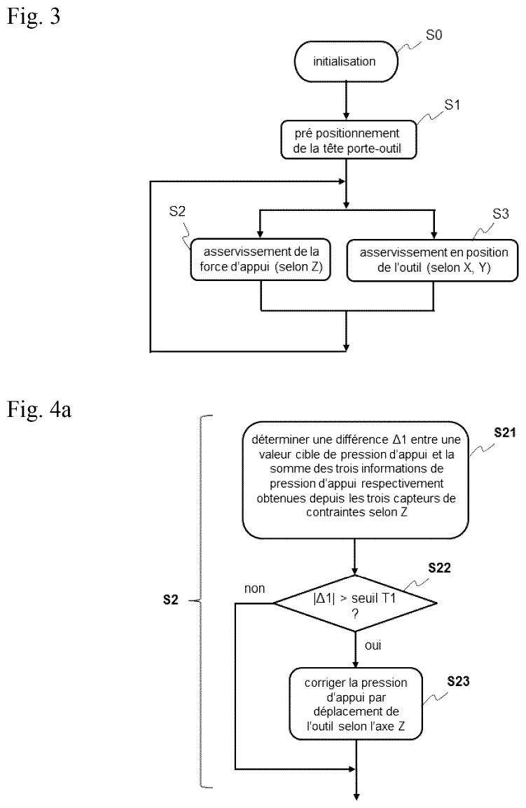

FIG. 3 is a flowchart illustrating an ingenious method for positioning (controlling the position of) the end effector 1 comprising two automatic controls of position that are carried out simultaneously for the purpose of preventing or limiting sliding (or skidding) of the tool 14 over the surface of a workpiece, on the basis of pieces of information representative of mechanical stresses (forces) measured via the three respective strain sensors 16a, 16b and 16c.

A step S0 is an initializing step, at the end of which all the systems and devices needed to control the multi-axis robot comprising the end effector 1 are normally initialized and operational. In a step S1, the end effector 1 is pre-positioned facing a workpiece so that the distal end part of the body 10 of the end effector 1 bearing the three strain sensors 16a, 16b and 16c is positioned facing and flush with the workpiece. According to one embodiment, the end effector 1 bears at least three optical laser transceiver modules that are each configured to measure a distance with high precision (of the order of one micron) between the module and the workpiece, and that are arranged in the same plane. According to this example, the three optical laser modules are connected to the control device 100, which is configured to take measurements of the relative position of the end effector 1 facing a workpiece.

Once the pre-positioning has been carried out in step S1, the method for positioning the end effector 1 comprises a step S2 of positioning the end effector 1 that aims to automatically control position so as to calibrate the clamping force of the end effector 1 against the workpiece, which step is carried out while performing a step S3 of positioning the end effector 1 with a view to obtaining a good distribution (a balanced distribution) of the stresses measured by the three respective strain sensors 16a, 16b and 16c, thus guaranteeing that the end effector 1 will not slip (or skid) with respect to the workpiece and therefore that the tool 14 will not slip (or skid) with respect to the surface of the workpiece. Specifically, frictional forces oriented perpendicular to the Z-direction may cause the end effector to slip over a workpiece, such as to imbalance the sought equality between the mechanical stresses applied to the sensors 16a, 16b and 16c. Ingeniously, a first automatic control of the position of the tool on the workpiece is carried out in step S2 in order to regulate the clamping force and, at the same time, a second automatic control of the position of the tool is carried out in step S3, simultaneously with the first automatic control, this allowing any slippage of the tool with respect to the workpiece to be prevented, or at the very least this risk or the amplitude of such an effect to be substantially reduced.

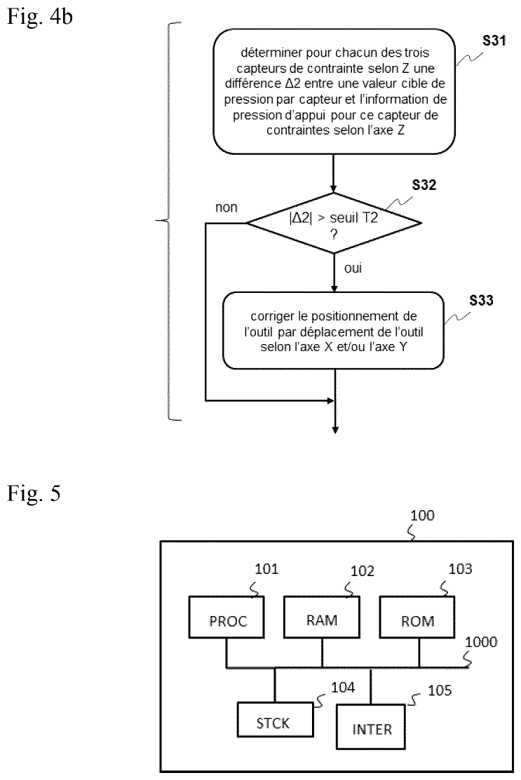

FIG. 4a is a flowchart illustrating details of implementation of the first automatic control effected in step S2, which here is broken down into three steps S21, S22 and S23.

In step S21, the control device 100 obtains pieces of information Se1, Se2 and Se3 representative of the mechanical stresses applied to the strain sensors 16a, 16b and 16c, respectively, in the Z-direction of the coordinate system X, Y, Z. The control device 100 then determines a difference Δ1 between a target clamping-pressure value (for example 100 daN for a predefined drilling operation) and the sum ΣSe of the three stresses determined from the three pieces of information representative of mechanical stresses obtained from the three strain sensors 16a, 16b and 16c, respectively. Next, the control device 100 determines, in a step S22, whether the absolute value |Δ1| is greater than a first predefined threshold value T1. If such is the case, then the position of the end effector 1 is corrected in step S23 by effecting a forward or backward movement of the end effector 1 with respect to the workpiece in the Z-direction, to increase or reduce the clamping pressure of the tool 14 against the workpiece, with a view to obtaining a predefined reference force (e.g., 100 daN). However, if the absolute value of the difference |Δ1| is not greater than the first predefined threshold value, then the clamping pressure of the tool 14 against the surface of the workpiece is within a satisfactory range of values and no correction is required at this stage.

FIG. 4b is a flowchart illustrating details of implementation of the second automatic control effected in step S3, which here is broken down into three steps S31, S32 and S33. In step S31, the control device 100 obtains pieces of information Se1, Se2 and Se3 representative of the mechanical stresses applied to the strain sensors 16a, 16b and 16c, respectively, in the Z-direction of the coordinate system X, Y, Z. The control device 100 then determines, for each of the sensors 16a, 16b and 16c, a difference Δ2 between a target clamping-pressure value (for example 1/3 of an overall target value of 100 daN, i.e., 33.33 daN, for a predefined drilling operation) to be applied to a sensor and the clamping pressure determined for this sensor, among the sensors 16a, 16b and 16c, from the pieces of information representative of mechanical stresses measured by this sensor and obtained from this sensor among the three sensors 16a, 16b and 16c.

Thus a difference Δ2Se1 is determined from the piece of information Se1 delivered by the sensor 16a, a difference Δ2Se2 is determined from the piece of information Se2 delivered by the sensor 16b and a difference Δ2Se3 is determined from the piece of information Se3 delivered by the sensor 16c.

Next, the control device 100 determines, in a step S32, whether the absolute value |Δ2| of each of the sensors 16a, 16b and 16c is greater than a second predefined threshold value T2 (and more precisely whether any of the differences Δ2Se1, Δ2Se2, and Δ2Se3 exceeds in absolute value the second predefined threshold value T2). If such is the case, then the position of the end effector 1 is corrected in step S33 by effecting a translational movement of the end effector 1 with respect to the workpiece in the X-direction and/or in the Y-direction, to compensate for the imbalance of the pressures observed on each of the three sensors 16a, 16b and 16c by the workpiece. However, if the absolute value of the difference |Δ2| is not greater than the second predefined threshold value, which condition needs to be met by each of the three sensors, then the imbalance of the clamping pressures against the surface of the workpiece is within a satisfactory range of values and no correction of position is required at this stage.

Advantageously, steps S2 and S3 are effected simultaneously (in parallel with each other) and are executed iteratively to generate the first automatic control of the position of the end effector 1, with a view to automatically controlling the pressure of the tool on the workpiece, and to generating, at the same time, the second automatic control of the position of the end effector 1, with a view to automatically controlling a balance of the mechanical stresses applied to each of the sensors 16a, 16b and 16c, thus guaranteeing an absence of slippage or at the very least a substantially reduced risk of slippage.

According to one embodiment, the first predefined threshold value T1 used in step S22 corresponds to a force of 3 kg and the correction of position along the Z-axis used in step S23 employs a “proportional-integral” calculation in the automatic control loops of the actuators of the robot.

$$Δ Z = dt [ Pz ( Σ FSei - {F}^{*} ) + Iz \int ( Σ FSei - {F}^{*} ) dt ]$$

where Pz is the proportional gain in the Z-direction, ΣFSei is the sum of the mechanical stresses Se1, Se2 and Se3, F* is the target clamping-pressure value, Iz is the integral gain in the Z-direction, and dt is the time increment of the controller.

According to one embodiment, the second predefined threshold value T2 used in step S32 corresponds to a force of 1.5 kg and the correction of position carried out in step S33 is effected by moving the end effector a distance ΔX in the X-direction and a distance ΔY in the Y-direction with the values ΔX and ΔY determined as explained below:

$$Δ X = dt [ Px ( cos 30 ° ( FSe 1 - {F}^{*} Se 1 ) - cos 30 ° ( FSe 2 - {F}^{*} Se 2 ) ) + Ix [ ( cos 30 ° ( FSe 1 - {F}^{*} Se 1 ) - cos 30 ° ( FSe 2 - {F}^{*} Se 2 ) ) dt ]$$

$$Δ Y = dt [ Py ( - sin 30 ° ( FSe 1 - {F}^{*} Se 1 ) - sin 30 ° ( FSe 2 - {F}^{*} Se 2 ) + ( FSe 3 - {F}^{*} Se 3 ) ) + Iy \int ( - sin 30 ° ( FSe 1 - {F}^{*} Se 1 ) - sin 30 ° ( FSe 2 - {F}^{*} Se 2 ) + ( FSe 3 - {F}^{*} Se 3 ) ) dt ]$$

and where Px and Py are the proportional gains in the X- and Y-directions, F*Sei is the target clamping-pressure value based on mechanical stresses, and Ix and Iy are the integral gains in the X- and Y-directions, respectively, and where FSe1, FSe2 and FSe3 are mechanical stresses determined from the pieces of information Se1, Se2 and Se3 representative of mechanical stresses delivered to the control device 100 by the sensors 16a, 16b and 16c, respectively.

Use of the method according to the invention has made it possible to observe, in the laboratory, a better balance between the forces measured on the sensors 16a, 16b and 16c around the average value, which is of the set clamping force, this greatly reducing the risk of the tool skidding over the surface of the workpiece.

FIG. 5 is a diagram illustrating one example of an internal architecture of the device 100 for controlling the positioning of the end effector 1, according to one embodiment.

In the hardware-architecture example shown in FIG. 5, the control device 100 then comprises, connected by a communication bus 1000: a processor or CPU (acronym of Central Processing Unit) 101; a random-access memory RAM 102; a read-only memory ROM 103; a storage unit such as a hard disk (or a reader of a storage medium such as an SD card (SD standing for Secure Digital)) 104; and at least one interface module 105 allowing the control device 100 to interact with devices present in the multi-axis robot comprising the end effector 1 and with other control devices of the robot, such as, for example, actuators of the robot or a programmable module for controlling workpiece-machining operations to be carried out by the robot. Advantageously, the interface module INTER 105 in particular comprises input/output ports, inputs for digital/analogue converters and for analogue/digital converters, pulse-width-modulation-controlled outputs, and more generally all types of interfaces, including power interfaces, useful for controlling a multi-axis industrial robot. In particular, the interface module INTER 105 of the control device 100 is configured to in particular effect functions to position the end effector of a robot.

The processor 101 is capable of executing instructions loaded into the RAM 102 from the ROM 103, from an external memory (not shown), from a storage medium (such as an SD card), or from a communication network. When the device 100 is turned on, the processor 101 is capable of reading program code instructions from the RAM 102 and of executing them. These instructions form a computer program that causes the processor 101 to implement all or part of the method described with reference to FIG. 3, FIG. 4a and FIG. 4b or all or some of the described variants of this method.

All or part of the method described with reference to FIG. 3, FIG. 4a and FIG. 4b or its described variants may be implemented in software form through execution of a set of instructions by a programmable machine, for example a digital signal processor (DSP) or a microcontroller, or may be implemented in hardware form by a dedicated machine or component, for example a field-programmable gate array (FPGA) or an application-specific integrated circuit (ASIC). In general, the device 100 for controlling positioning of the end effector 1 comprises electronic circuitry configured to implement the methods described in relation to the end effector 1 or the control device 100. Of course, the device 100 for controlling the position of the end effector 1 further comprises all of the elements usually present in a system comprising a control unit and its peripherals, such as a circuit for supplying power, a circuit for supervising the supply of power, one or more clock circuits, a zeroing circuit, related input/output ports, interrupt inputs, and bus drivers, this list being non-exhaustive.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A method for positioning an end effector of a multi-axis robot, said end effector being configured to bear a tool extending longitudinally in a first direction and said end effector comprising at least three strain sensors configured to deliver pieces of information representative of stresses exerted on said end effector in the Z-direction, said method being executed in a device for controlling positioning of said end effector, said device being connected to said three strain sensors and connected to positioning actuators of said robot, which are configured to position said end effector in at least said first direction and two other directions that are perpendicular to each other and each perpendicular to said first direction, said method being characterized in that it comprises, executed iteratively, the following steps:
obtaining three first pieces of information representative of stresses exerted in the first direction, which pieces of information are obtained from said three sensors, respectively,
effecting a first automatic control of the position of said end effector in the first direction based on said three first pieces of information while effecting a second automatic control of the position of said end effector in the other two directions based on said three first pieces of information.

2. The method for positioning an end effector of a multi-axis robot according to claim 1, wherein effecting said first automatic control of the position of said end effector comprises:
determining a first difference between the sum of said three first pieces of information and a predetermined target stress in the Z-direction, and,
when said determined first difference is greater than a predefined first threshold value, correcting a positioning setpoint of said end effector of said robot in the first direction so as to reduce said first difference, and wherein effecting said second automatic control of the position of said end effector comprises:
determining second differences between the average of said three first pieces of information and each of said first pieces of information and,
when at least one of said determined second differences is greater than a predefined second threshold value, correcting a positioning setpoint of said end effector of said robot in either or both of said two other directions so as to reduce said second difference or differences.

3. The method for positioning an end effector of a multi-axis robot according to claim 1, the method further comprising a preliminary step of positioning said end effector facing and flush with a surface of a workpiece by virtue of at least three optical laser transceiver modules.

4. The method for positioning an end effector of a multi-axis robot according to claim 1, the method being configured to effect drilling operations on aeronautical-equipment parts by means of said multi-axis robot bearing a drilling tool.

5. A device for controlling the position of an end effector of a multi-axis robot, said end effector being configured to bear a tool extending longitudinally in a first direction and said end effector comprising at least three strain sensors configured to deliver pieces of information representative of stresses exerted on said end effector in the first direction, said device for controlling the position of said end effector being connected to said three strain sensors and being connected to positioning actuators of said robot, which are configured to position said end effector in at least said first direction and two other directions that are perpendicular to each other and each perpendicular to said first direction, said control device being characterized in that it comprises electronic circuitry configured to:
obtain three first pieces of information representative of stresses exerted in the first direction, from said three sensors, respectively,
effect a first automatic control of the position of said end effector in the first direction based on said three first pieces of information while effecting a second automatic control of the position of said end effector in the other two directions based on said three first pieces of information.

6. A device for controlling positioning of an end effector of a multi-axis robot according to claim 5, wherein the electronic circuitry configured to effect said first automatic control comprises electronic circuitry configured to:
determine a first difference between the sum of said three first pieces of information and a predetermined target stress in the first direction, and to,
when said determined first difference is greater than a predefined first threshold value, correct a positioning setpoint of said end effector of said robot in the first direction so as to reduce said first difference,
and wherein the electronic circuitry configured to effect said second automatic control of the position of said end effector comprises electronic circuitry configured to:
determine second differences between the average of said three first pieces of information and each of said first pieces of information, respectively, and to,
when at least one of said determined second differences is greater than a predefined second threshold value, correct a positioning setpoint of said end effector of said robot in either or both of said two other directions so as to reduce said second difference or differences.

7. The device for controlling positioning of an end effector of a multi-axis robot according to claim 5, further comprising electronic circuitry configured to effect preliminary positioning of said end effector facing and flush with a target surface of a workpiece by virtue of at least three optical laser transceiver modules.

8. The device for controlling the position of an end effector of a multi-axis robot according to claim 5, the control device being configured to position said end effector to effect drilling operations on aeronautical-equipment parts by means of said multi-axis robot bearing a drilling tool.

9. A computer program product comprising program code instructions for executing the steps of the method according to claim 1, when said program is executed by a processor of a device for controlling positioning of an end effector of a multi-axis robot.

10. A storage medium comprising a computer program product according to claim 9.
